(19) United States
(12) Patent Application Publication
(10) Pub. No.: US 2019/0006859 A1
(43) Pub. Date: Jan. 3, 2019

(54) SYSTEM AND METHOD FOR PROTECTING A BATTERY DURING SUDDEN LOAD REDUCTION

(71) Applicant: PHINERGY LTD., Lod (IL)

(72) Inventors: Menachem POLAK, Herut (IL); Yisrael MILLER, Bat Ayin (IL); Christophe DANG-VAN NHAN, VILLEJUIF (FR)

(73) Assignee: PHINERGY LTD., Lod (IL)

(21) Appl. No.: 16/067,616

(22) PCT Filed: Dec. 29, 2016
(86) PCT No.: PCT/IL2016/051399

§ 371 Date: Jul. 2, 2018

Related U.S. Application Data
(60) Provisional application No. 62/274,299, filed on Jan. 3, 2016.

(51) Int. Cl. H02J 7/00; H01M 10/42; H01M 8/04858; H01M 8/043; H01M 8/04537

(52) U.S. Cl. CPC H02J 7/0029; H02J 7/0063; H01M 10/425; H02J 2007/0067; H01M 8/043; H01M 8/04604; H01M 8/04925

(57) ABSTRACT

System and method for connection of a substitute load in batteries that are adapted to provide electrical power to an external power consuming unit. The batteries are connected to an electrical power consuming element, that is connectable to the batteries in case of undesired disconnection of the external power consuming unit. A controllable switching unit is configured to connect the power consuming element between the anode and the cathode when a load sensing unit senses ‘reduced load’ status of the electrical load between the anode and the cathode of the battery.

### FIELD OF THE INVENTION

The present invention relates to batteries undergoing oxidation. More particularly, the present invention relates to systems and methods for protecting batteries during sudden load reduction.

### BACKGROUND OF THE INVENTION

Typical commercially available batteries have an anode and a cathode that convert stored chemical energy into electrical energy, and when connected to an external circuit will deliver energy to an external device. When such a battery is connected to an external circuit, ions are able to move within (as the current), thereby allowing the chemical reactions to be completed and thus deliver energy to the external circuit.

A metal-air battery is an electrochemical cell that uses an anode made from pure metal and also an external cathode of ambient air, typically with an aqueous electrolyte. In normal operation of a metal-air battery, electric energy is created by oxidizing a metal anode. In addition to the electrochemical reaction, a metal anode reacts with the electrolyte (e.g. alkaline) through a corrosion reaction. For example, in an aqueous Aluminum-air battery, the electrochemical reaction that generates the electric energy is:

4Al+6H₂O+3O₂=>4Al(OH)₃

Whereas the corrosion reaction is:

2Al+6H₂O=>2Al(OH)₃+3H₂

The corrosion reaction usually results also in the release of heat. In addition, since the Oxygen (O₂) for the corrosion is taken from the electrolyte (rather than the cathode), the corrosion therefore also produces Hydrogen (H₂). For both reasons, corrosion can impose a safety hazard if it exists in a high rate at the battery.

Usually, energy generation and corrosion “compete” for the surface of the metal anode. Therefore, increasing the current draw from a cell, and thereby increasing the electrochemical reaction, reduces the rate of corrosion, and vice versa.

A metal-air battery may be connected to electrical loads (herein after ‘loads’ or ‘load’) of various types, such as stationary systems or electric vehicles. During its operation, the battery might be suddenly disconnected from the electric load if the electric consumer system undergoes a problem (for instance an accident in an electric vehicle). In this case, the electrochemical reaction is stopped, and corrosion increases, thereby in turn, causing a safety hazard.

Therefore, a need arises for a way to protect batteries in extreme conditions wherein the load is suddenly disconnected from the battery.

### SUMMARY OF THE INVENTION

A system and method are disclosed for connection of a substitute load in batteries comprising a metal anode undergoing oxidation and a cathode that are adapted to provide electrical power to an external power consuming unit. The batteries are adapted to be connected to an electrical power consuming element, that is connectable to the batteries in case of undesired disconnection of the external power consuming unit. The system comprising an electrical power consuming element that may controllably be electrically coupled between the anode and the cathode, a controllable switching unit that is configured to allow electrical connection of the power consuming element between the anode and the cathode and a load sensing unit that is configured to sense ‘reduced load’ status of the electrical load between the anode and the cathode and to electrically connect the power consuming element between the anode and the cathode in response to the sensing of the ‘reduced load’ status by said load sensing unit.

In some embodiments the power consuming element comprises a load resistor.

In some embodiments the controllable switching unit comprises a switch.

In some embodiments the controllable switching unit comprises a contactor.

In some embodiments the anode is surrounded by liquid, and wherein the power consuming element is configured to heat the liquid when connected to the anode.

In some embodiments the power consuming element comprises a heating element.

According to some embodiments a power storage apparatus is disclosed comprising a cathode and a metal anode coupled to an electrical load, a control element that is configured to allow electrical connection of the power consuming element between the anode and the cathode and a load sensing unit that is configured to sense ‘reduced load’ status of the electrical load between the anode and the cathode and to electrically connect the power consuming element between the anode and the cathode in response to the sensing of the ‘reduced load’ status by said the sensing unit.

A method of operating a battery with a metal anode is disclosed comprising connecting an external power consuming unit to a battery with a metal anode, connecting a power consuming element via a controllable switch between the anode and cathode of the battery, sensing by a load sensing unit the power provided by the battery and activating the controllable switch to connect the power consuming element between the anode and the cathode when ‘reduced load’ is sensed by the load sensing unit.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a commercially available electric system with a metal-air battery;

FIG. 2 schematically illustrates a system for reduction of corrosion in batteries, according to an exemplary embodiment of the invention;

FIG. 3 schematically illustrates a system for reduction of corrosion in batteries with a liquid container, according to an exemplary embodiment of the invention;

FIG. 4 schematically illustrates a system for reduction of corrosion in batteries with a liquid container and a heating element, according to an exemplary embodiment of the invention; and

FIG. 5 schematically illustrates a system for reduction of corrosion in batteries with an external electric consumer having a liquid container and a heating element, according to an exemplary embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

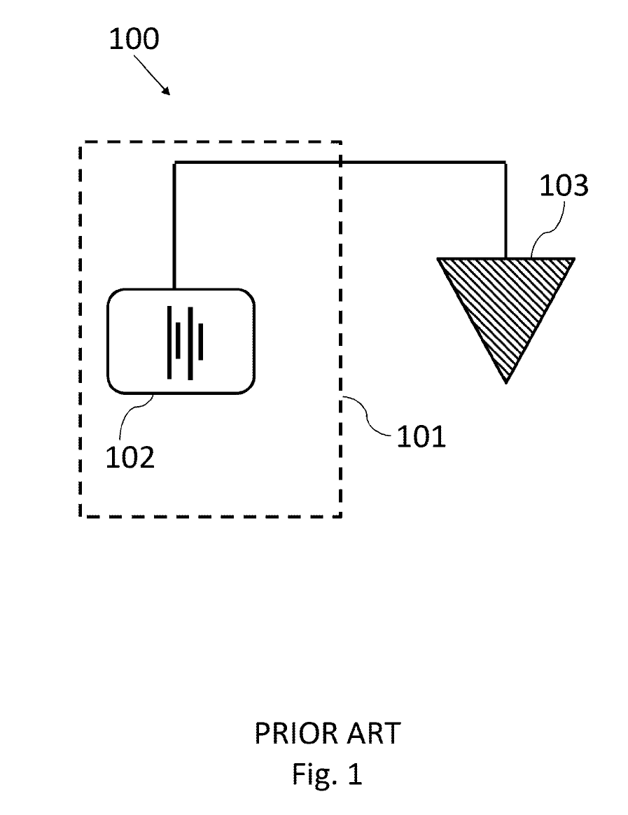

Reference is now made to FIG. 1, which schematically illustrates a commercially available electric system with a metal-air battery, generally designated 100. The commercially available electric system 100 comprises a metal-air battery 101 (indicated with a dashed line), and an external electric consumer 103 as an electrical power consuming element (or load). For example, an electric car's engine as the external electric consumer 103 with at least one metal-air battery 101 powering the engine, whereby the engine acts as a load on the at least one metal-air battery 101.

It is appreciated that electrical circuits shown in the drawings are schematic and are not designed to present actual electrical circuits (for example, a line connected to the cathode is not drawn).

The metal-air battery 101 may comprise at least one metal-air cell 102, with a metallic anode and also an air cathode. In case of a sudden load reduction (for instance malfunction of the electric car), the anode of the metal-air cell 102 is no longer electrically connected to the external electric consumer 103 and thus the anode may be affected by corrosion. It would therefore be advantageous to prevent such corrosion.

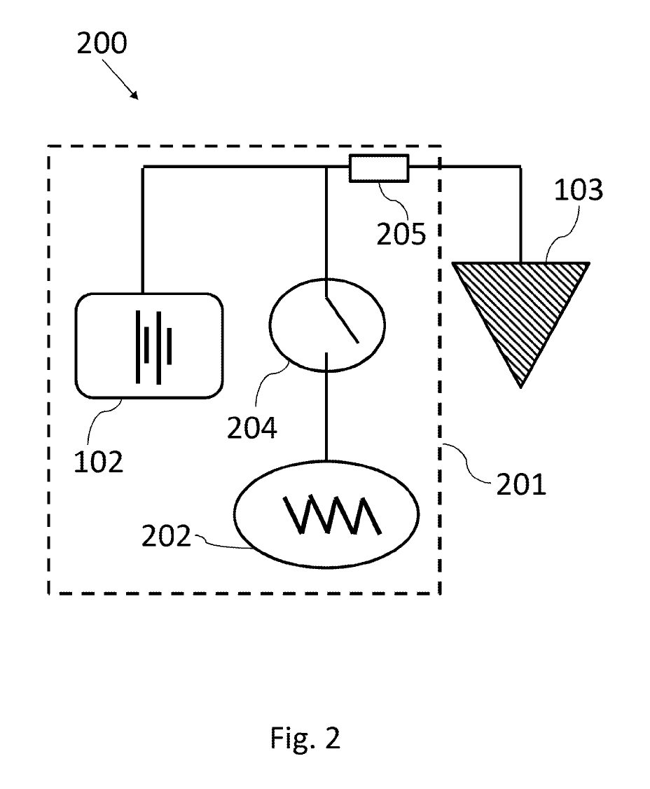

Reference is now made to FIG. 2, which schematically illustrates a system for reduction of corrosion in batteries, generally designated 200, according to some embodiments of the invention. The corrosion reduction system 200 comprises a modified metal-air battery 201 (indicated with a dashed line) with an additional electrical power consuming element 202 (e.g. a resistor) that is controllably electrically coupled between the at least one metal-air cell 102 and the external electric consumer 103.

In some embodiments, the electrical coupling of the electrical power consuming element 202 between anode and cathode of the metal-air cell 102 may be carried out with a controllable switching unit 204. The controllable switching unit 204 is configured to allow electrical connection of the power consuming element 202 between the anode and cathode of the metal-air cell 102, upon occurrence of reduced load (from the electric consumer 103) on the metal-air cell 102.

When the switching unit 204 allows the electrical connection of the electrical power consuming element 202 between the anode and cathode of the metal-air cell 102, electric energy from the metal-air cell 102 may be consumed by the power consuming element 202 such that the electrochemical reaction continues.

It should be noted that in cases where the load of the external electric consumer 103 is removed, the metal anode of the metal-air cell 102 undergo corrosion. Therefore, the hazard of increased corrosion in case of reduced load in the metal-air battery may be reduced (or even eliminated) when an additional (or replacement) load is electrically coupled to the metal-air cell 102.

In some embodiments, the controllable switching unit 204 is an electromechanical switch. In other embodiments, the controllable switching unit 204 is a contactor.

In some non-limiting embodiments, the corrosion reduction system 200 further comprises a load sensing unit 205 that is configured to give an indication of reduced load status between the anode and cathode of the metal-air cell 102. Thus, upon sensing and indicating of reduced load status from the load sensing unit 205, a signal (e.g. digital signal) may pass to the switching unit 204 so as to allow the electrical connection of the power consuming element 202 between the anode and cathode of the metal-air cell 102.

In some embodiments, the switching unit 204 may operate without a load sensing unit, such that upon sudden load reduction the power consuming element 202 may be automatically connected between the anode and cathode of the metal-air cell 102.

It is appreciated that during normal operation of the system 200, i.e. with usual load on the battery (without indication of “reduced load status”), the additional electrical power consuming element 202 may be disconnected from the metal-air cell 102.

Thus, the corrosion reduction system 200 is configured to allow connection of a substitute load (i.e. the power consuming element 202) in batteries comprising a metal anode undergoing oxidation and a cathode, adapted to provide electrical power to a power consuming load 102, and connectable to an external electrical power consuming element 103, in case of undesired disconnection of the power consuming load 102.

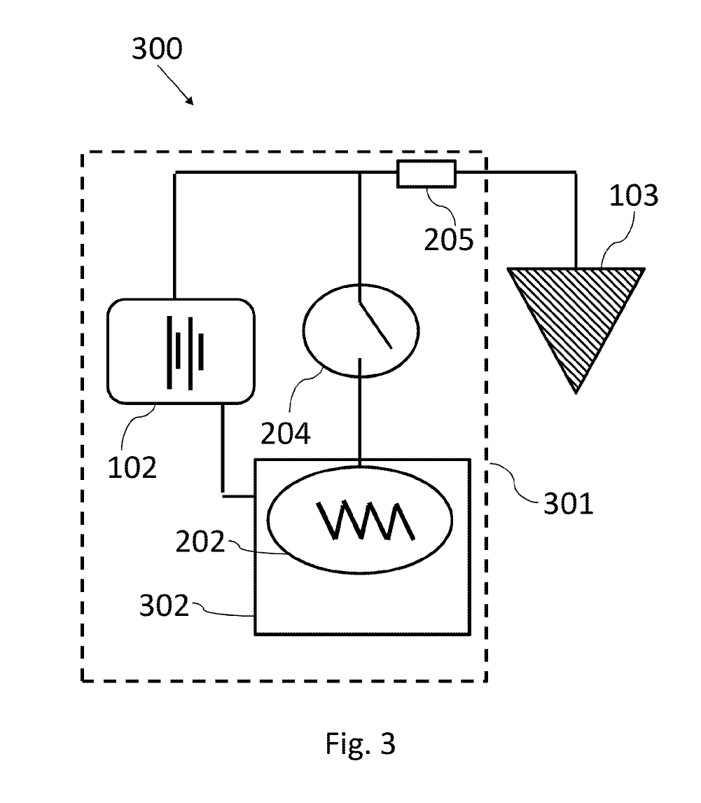

Reference is now made to FIG. 3, which schematically illustrates a system for reduction of corrosion in batteries with a liquid container, generally designated 300, according to some embodiments of the invention. It is appreciated that some metal-air batteries 301 include a liquid container 302, such as an electrolyte tank (for instance in Aluminum-air systems), in order to contain the electrolyte of the battery.

By positioning the power consuming element 202 inside the liquid container 302, upon indication of reduced load (e.g. from the load sensing unit 205), it may be possible to direct the electrical current to the power consuming element 202 so as to also heat the liquid inside the liquid container 302. Thus, power continues to be consumed from the metal-air cell 102 with the result of non-hazardous heating of the liquid.

It is appreciated that by employing the power consuming element 202 inside the liquid container 302, both size and weight of the metal-air battery 301 may be saved since there is no need for an additional space consuming element in the battery.

Some metal-air batteries have a shut-down procedure, for example in case of emergency an Aluminum-air battery may commence a shut-down operation by draining the electrolyte cells. In some non-limiting embodiments, by keeping the power consuming element 202 connected to the metal-air battery until completion of the shut-down procedure, an occurrence of reduced load (causing increased oxidation) may be prevented. For example, in case of emergency the power consuming element 202 is connected to the metal-air battery as long as draining of the cells continues.

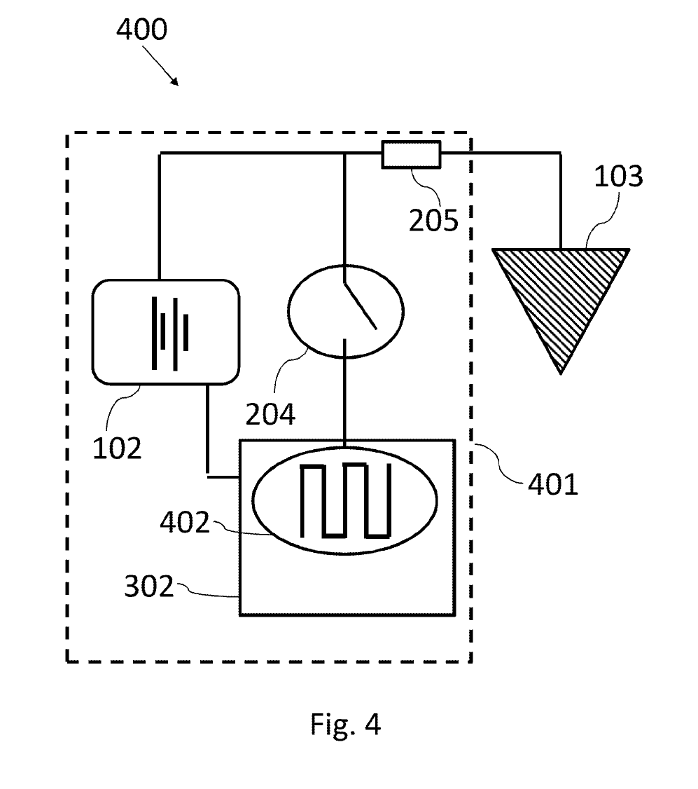

Reference is now made to FIG. 4, which schematically illustrates a system for reduction of corrosion in batteries with a liquid container and a heating element, generally designated 400, according to some embodiments of the invention.

In some embodiments, the modified battery 401 may be provided with the power consuming element as a dedicated heating element 402 that is configured to allow heating of the electrolyte (due to electric current induced from the metal-air cell 102). It is appreciated that the heating element 402 may therefore save both space and weight of the metal-air battery 401.

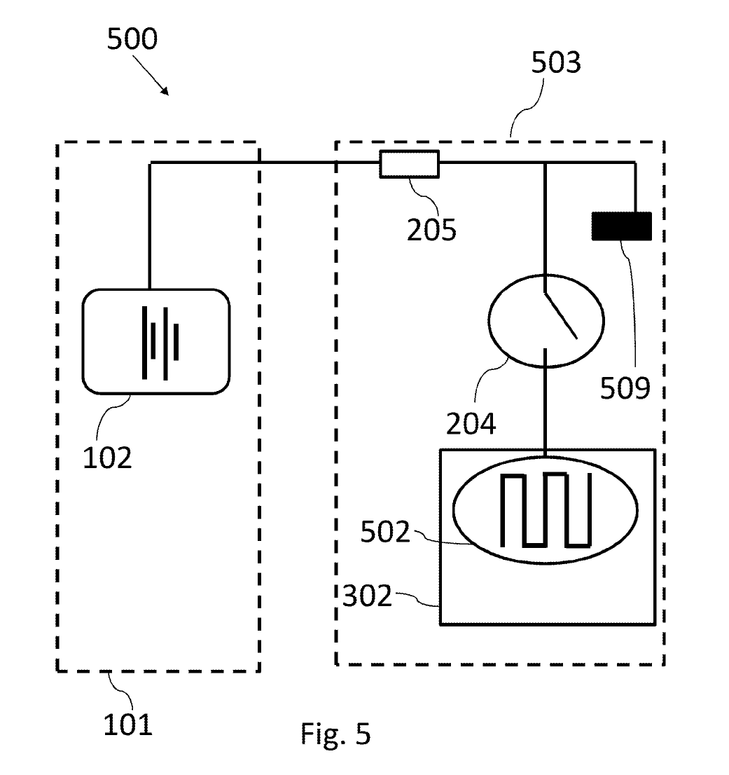

Reference is now made to FIG. 5, which schematically illustrates a system for reduction of corrosion in batteries with an external electric consumer 503 having a liquid container 302 and a heating element 502, generally designated 500, according to some embodiments of the invention.

In some embodiments, the external electric consumer 503 includes a power consuming load 509 and also utilizes a heating element 502. Thus, the heating element 502 of the external electric consumer 503 may be employed as the additional power consuming element (for instance element 202 in FIG. 2). For example, a heating system of a vehicle may include a fan 509 and a heating element 502 inside a tank of liquid 302 as the modified battery system in order to reduce corrosion.

The heating element 502 may therefore be electrically connected to the switching unit 204, so as to allow electrical coupling of the heating element 502 between the anode and cathode of the metal-air cell 102. Thus, upon indication of a reduced load (e.g. engine malfunction in an electric car), the metal-air cell 102 may be coupled to the heating element 502 instead of a direct connection to the external electric consumer 503 (e.g. the engine) and therefore protect the metal-air battery 101 from corrosion.

It is appreciated that while metal-air batteries were described above, any other type of battery may be modified in a similar way in order to protect the battery from the hazard of corrosion upon sudden load reduction. Furthermore, while a single battery was described above, any number of batteries may be similarly coupled to an additional electrical load in order to protect the batteries.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system for connection of a substitute load in batteries comprising a metal anode undergoing oxidation and a cathode, adapted to provide electrical power to a power consuming unit, and connectable to an external electrical power consuming element, in case of undesired disconnection of the power consuming unit, the system comprising:
an electrical power consuming element, controllably electrically coupled between the anode and the cathode;
a controllable switching unit, configured to allow electrical connection of the power consuming element between the anode and the cathode; and
a load sensing unit, configured to sense ‘reduced load’ status of the electrical load between the anode and the cathode,
wherein the controllable switching unit is adapted to electrically connect the power consuming element between the anode and the cathode in response to the sensing of the ‘reduced load’ status by said load sensing unit.

2. The system according to claim 1, wherein the power consuming element comprises a load resistor.

3. The system according to claim 1, wherein the controllable switching unit comprises a switch.

4. The system according to claim 1, wherein the controllable switching unit comprises a contactor.

5. The system according to claim 1, wherein the anode is surrounded by liquid, and wherein the power consuming element is configured to heat the liquid when connected to the anode.

6. The system according to claim 1, wherein the power consuming element comprises a heating element.

7. A power storage apparatus, comprising:
a cathode and a metal anode, coupled to an electrical load;
an electrical power consuming element, controllably electrically coupled to the anode;
a control element, configured to allow electrical connection of the power consuming element between the anode and the cathode; and
a load sensing unit, configured to sense ‘reduced load’ status of the electrical load between the anode and the cathode,
wherein the control element is adapted to electrically connect the power consuming element between the anode and the cathode in response to the sensing of the ‘reduced load’ status by said load sensing unit.

8. The apparatus according to claim 7, wherein the power consuming element comprises a load resistor.

9. The apparatus according to claim 7, wherein the control element comprises a switch.

10. The apparatus according to claim 7, wherein the control element comprises a contactor.

11. The apparatus according to claim 7, wherein the anode is surrounded by liquid, and wherein the power consuming element is configured to heat the liquid when connected to the anode.

12. The apparatus according to claim 7, wherein the power consuming element comprises a heating element.

13. A method comprising:
connecting an external power consuming unit to a battery with a metal anode;
connecting a power consuming element via a controllable switch between the anode and cathode of the battery;
sensing, by a load sensing unit, the power provided by the battery; and
activating the controllable switch to connect the power consuming element between the anode and the cathode when ‘reduced load’ is sensed by the load sensing unit.
